(19) United States
(12) Patent Application Publication
(10) Pub. No.: US 2024/0126446 A1
(43) Pub. Date: Apr. 18, 2024

(54) MANAGEMENT OF MULTI-TYPE STORAGE INCLUDING HYPERCONVERGED STORAGE

(71) Applicant: VMware, LLC, Palo Alto, CA (US)

(72) Inventors: Yang Yang, Shanghai (CN); Yu Wu, Shanghai (CN); Jin Feng, Shanghai (CN); Hui Xu, Shanghai (CN); Zhuocheng Shen, Shanghai (CN); Rajesh Venkatasubramanian, San Jose, CA (US)

(21) Appl. No.: 18/075,531

(22) Filed: Dec. 6, 2022

(30) Foreign Application Priority Data
Oct. 18, 2022 (WO) PCT/CN2022/125823

(51) Int. Cl. G06F 3/06

(52) U.S. Cl. CPC G06F 3/0616; G06F 3/0647; G06F 3/0653; G06F 3/067

(57) ABSTRACT

Described herein are systems, methods, and software to manage multi-type storage in a cluster computing environment. In one example, a host can identify health and performance information at a first time for each local data store on the host and a hyperconverged data store available to the host. The host can further identify health and performance information associated with the data stores at a second time and can compare the health and performance information at the first time and the second time to identify differences in the information. The host then communicates the differences to a second host in the computing environment.

### RELATED APPLICATIONS

This application claims benefit from and priority to PCT Application Serial No. PCT/CN2022/125823 filed in China entitled “MANAGEMENT OF MULTI-TYPE STORAGE INCLUDING HYPERCONVERGED STORAGE”, on Oct. 18, 2022, which is herein incorporated in its entirety by reference for all purposes.

### BACKGROUND

In computing environments, virtual machines are deployed across hosts to efficiently use the storage, processing, networking, and other resources of the hosts. Each of the hosts can abstract the physical resources of the host and provide the resources to the virtual machine, including processing resources, memory resources, storage resources, networking resources, or some other resources.

In some examples, a computing environment can deploy different types of data stores, include local data stores and hyperconverged data stores that can be distributed over multiple hosts of the computing environment. The local data stores can include virtual machine file system (VMFS) data stores, persistent memory (PMem) data stores, or some other local data store. The virtual machines can each use files or objects from both a local data store and the hyperconverged data store. For example, a virtual machine on a first host can be allocated a home folder or disk object from a local data store, while one or more additional disk objects are mounted to the virtual machine from the hyperconverged data store.

However, while the virtual machines can use multiple data stores, difficulties exist for administrators in determining the effects of a failure associated with a local data store on other reliant data stores. For example, when a virtual machine that uses both local and hyperconverged data stores encounters a failure with the local data store, orphan objects, or unclaimed objects on the hyperconverged storage can be created. This can create inefficiencies as no virtual machine can be assigned to use the resources of the orphan objects during the downtime of the local data store.

### Overview

The technology disclosed herein manages multiple storage types, including local storage on hosts and hyperconverged storage across multiple hosts. In one implementation, a method includes for each local data store of one or more local data stores on a first host, identifying first health and performance information at a first time and identifying second health and performance information at a second time, wherein the second time is after the first time. The method further includes determining that one or more values in the second health and performance information differ from the one or more values in the first health and performance information by a threshold amount. Once the one or more values are determined, the method also communicates an update to a second host that indicates that one or more values identified at the second time.

In another implementation, a method includes, for at least one host in a computing environment, identifying a data store location for each object (e.g., disk file) associated with each virtual machine on the at least one host. The method further provides for determining orphan objects in a hyperconverged data store based on a failure to a local data store and the identified data store locations of the one or more objects. Once the orphan objects are identified, the method further includes generating a summary of the orphan objects, wherein the summary can indicate the orphaned objects, the virtual machines associated with the orphaned objects, or available operations to mitigate the failure of the local data store.

### BRIEF DESCRIPTION OF THE DRAWINGS

FIG. 1 illustrates a computing environment for managing health and performance information in association with local and hyperconverged data stores according to an implementation.

FIG. 2 illustrates a method of operating a host to manage health and performance information in association with local and hyperconverged data stores according to an implementation.

FIG. 3 illustrates a method to identify orphan objects in a computing environment according to an implementation.

FIG. 4 illustrates an operational scenario of managing health and performance information for local and hyperconverged data stores according to an implementation.

FIG. 5 illustrates a data structure for providing a summary associated with health and performance information according to an implementation.

FIG. 6 illustrates an operational scenario of providing an orphan object summary according to an implementation.

FIG. 7 illustrates a host computing system to manage health and performance information in association with local and hyperconverged data stores according to an implementation.

### DETAILED DESCRIPTION

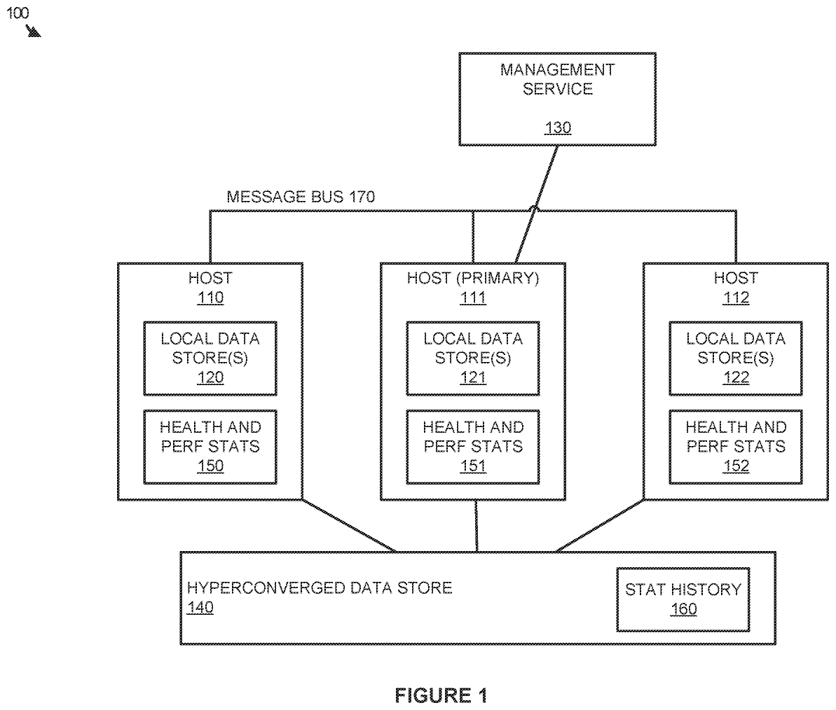

FIG. 1 illustrates a computing environment for managing health and performance information in association with local and hyperconverged data stores according to an implementation. Computing environment 100 includes hosts 110-112, management service 130, and hyperconverged data store 140. Hosts 110-112 are coupled via at least message must 170 and include local data stores 120-122 and health and performance statistics 150-152. Hyperconverged data store 140 includes statistic history 160, which is representative of cached statistic history in association with local and hyperconverged data stores. Although demonstrated as separate from hosts 110-112, hyperconverged data store 140 can be located wholly or partially on hosts 110-112 and can be at least partially located on one or more other computers. Further, while demonstrated as separate from hosts 110-112, management service 130 can be implemented wholly or partially on host 111 that aggregates health and performance statistics and information for hosts 110-112 of computing environment 100. Although demonstrated with three hosts in the example of computing environment 100, any number of hosts can be included in a computing environment. Hosts 110-112 can communicate health and performance information via message bus 170, which is representative of a control plane between hosts 110-112.

In computing environment 100, hosts 110-112 provide a platform for virtual machines, wherein the hosts 110-112 provide a platform for the virtual machines. Hosts 110-112 can provide processing resources, storage resources, memory resources, networking resources, and other resources to virtual machines executing on each of the hosts. In some implementations, each of the virtual machines can mount disk objects that are located on local data stores (i.e., data stores exclusive to a host) or hyperconverged data stores that are distributed across hosts and/or one or more computing systems. For example, host 110 can execute a virtual machine that includes at least one disk (or virtual disk) from local data store(s) 120 and at least one disk from hyperconverged data store 140.

As the virtual machines execute in computing environment 100, hosts 110-112 can maintain health and performance information in association with health and performance. The information is represented in computing environment 100 as heath and performance statistics 150-152. Each host of hosts 110-112 will maintain local health and performance information in association with their corresponding local data store(s) 120-122. The local data stores can comprise virtual machine file system (VMFS) data stores, Persistent memory (PMem) data stores, or some other type of data store. For example, host 112 can maintain health and performance information in association with local data store(s) 112. The health and performance information can include disk or storage health information, latency information, bandwidth information, input/output operations per second (IOPS), or some other health and performance metric. As the information is gathered, hosts 110 and 112 can report updates for the information to host 111. Host 111 can be selected as the aggregating host based on administrator selection for computing environment 100, based on resource usage associated with hosts 110-112, wherein a host is selected with the least resource usage, or based on some other factor. After the health and performance information is provided from hosts 110 and 112, host 111 can aggregate the information in association with the different hosts of computing environment 100. The information can be communicated to host 111 at periodic intervals, when a value for the health and performance information indicates an update is required, or at some other interval. Hosts 111 can then maintain the health and performance information and provide the maintained information to management service 130. Management service 130 can generate and provide a display of the aggregated health and performance information to an administrator of computing environment 100.

Additionally, management service 130 can determine how a failure of at least one local data store will affect objects in hyperconverged data store 140. The objects can include one or more disk files, configuration files, and the like that are indicated for each virtual machine on the host. For example, if a data store fails on host 111, management service 130 can identify orphan or unclaimed objects in association with virtual machines that include at least one object on the local data store, wherein the orphan object can be located on other local data stores or hyperconverged data store 140. Once the orphan objects are identified, management service 130 can provide a summary to an administrator of computing environment 100. In some examples, a user generates a request in association with a data store to determine how a failure will affect other objects located on other data stores. The user may generate the request in anticipation of a failure of the data store either intentionally (through an update or configuration change), or unintentionally (via a failure to one or more storage devices or the storage controller). In response to the request, management service 130 can identify virtual machines with objects on the data store and identify orphan objects for the virtual machines on one or more other data stores. A summary can then be provided to an administrator by management service 130, wherein the summary can indicate the orphan disks, virtual machine identifiers for virtual machines affected by the failure, or some other information. A summary can also be provided by management service 130 when a failure or potential failure is identified through the aggregated health and performance information supplied by host 111.

In at least one example, management service 130 uses the configuration files associated with the virtual machines to identify the objects associated with each of the virtual machines. The configuration files can indicate storage locations for the various objects required by the virtual machines, including data store identifiers, file paths, or some other information about the locations of the various data stores.

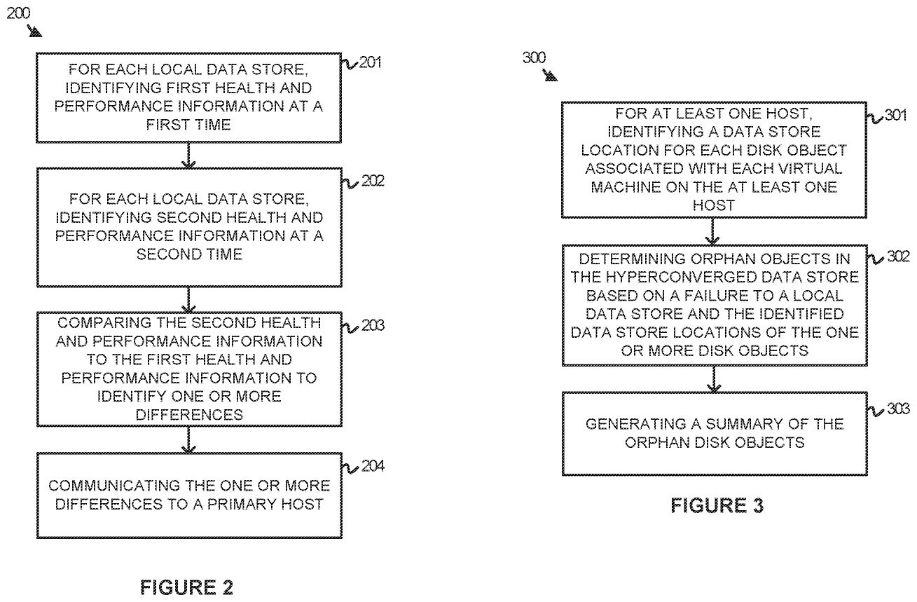

FIG. 2 illustrates a method 200 of operating a host to manage health and performance information in association with local and hyperconverged data stores according to an implementation. The steps of method 200 are referenced parenthetically in association with host 112 of computing environment 100. However, host 110 can provide similar operations in association with health and performance information associated with host 110.

Method 200 includes identifying (201), for each local data store, first health and performance information at a first time. The health and performance information can comprise disk health information, latency information, bandwidth information, IOPS information, or some other health and performance metric. The data store can comprise one or more storage devices, partitions, or other data store that is allocated on host 112. In addition to gathering the first health and performance information, method 200 further includes identifying (202), for each local data store, second health and performance information at a second time, wherein the second time occurs after the first time. In some examples, each host can identify the health and performance information at periodic intervals. For example, host 112 can monitor health and performance information for local data store(s) 112 every hour.

Once the health and performance information are identified at the first and second time, method 200 further provides for comparing (203) the second health and performance information for the one or more local data stores to the first health and performance information for the one or more local data stores to identify one or more differences in values. In some examples, the differences will only be identified when a value satisfies criteria or exceeds a threshold value. For example, at a first time a local data store on host 112 may comprise a first capacity usage, while at a second time the local data store may comprise a second capacity usage. If the second capacity usage does not differentiate from the first capacity usage by a threshold amount, then host 112 can determine that no change occurred from the first to the second time. If the second capacity usage does exceed the threshold, then a difference will be identified by host 112. Thus, while a difference is identified between a first value at a first time and a second value at a second time, the second value will only be identified as an update when the difference between the first and second values satisfy criteria.

After the one or more differences are identified for communication to the primary host, method 200 further includes communicating (204) an update to host 111 based on the identified one or more differences. Returning to the example of capacity usage for a local data store, host 112 will provide an update that indicates the capacity usage at the second time. In communicating the update, host 112 will not communicate information about unchanged health and performance information (or health and performance information that does not satisfy criteria indicating an update is required). Thus, if no differences were identified from the first time to the second time, then no update information is provided to host 111 or host 112 can indicate that no changes occurred from the first time to the second time.

Once the update is received by host 111, host 111 can compile the health and performance information for hosts 110-112. The compiled or aggregated information can be stored in hyperconverged data store 140 as statistic history 160 and can be provided to management service 130 as an aggregated health and performance information summary, wherein management service 130 can generate a visual summary or display for an administrator of computing environment 100. In some examples, host 111 can cache the most recent health and performance information for hosts 110-112 in health and performance statistics 151, such that the most recent information can be efficiently provided to management service 130 as an aggregated health and performance information summary.

In some implementations, in addition to collecting the health and performance information for local data store(s) 122, host 112 can also be assigned to monitor health and performance information associated with hyperconverged data store 140. A host of hosts 110-112 can be selected based on the resource usage at each of the hosts. In at least one example, hosts 110-112 can exchange information about the processing, memory, and other resource usage on each of the hosts. Based on the exchanged information, a host can be selected (by primary host 111) to monitor hyperconverged data store 140. The selected host can then monitor the health and performance information for hyperconverged data store 140 in a similar manner to the local data stores, wherein the health and performance information can include capacity usage associated with the data store, latency, storage device health, bandwidth, IOPS, or some other information in association with the hyperconverged data store 140. As an example, when host 112 is selected to monitor hyperconverged data store 140, host 112 can determine when the health and performance information differ between a first time and a second time and communicate the differences to host 111. The communicated information can be aggregated with the health and information for the local data stores at each of the hosts by host 111. The aggregated information can then be communicated as a summary to management service 130.

FIG. 3 illustrates an operation 300 to identify orphan objects in a computing environment according to an implementation. The steps of operation 300 are referenced parenthetically in the paragraphs that follow with reference to systems and elements of computing environment 100. Operation 300 can be performed entirely by management service 130 or can be implemented at least partially using host 111.

Method 300 includes, for at least one host in computing environment 100, identifying (301) a data store location for each disk object associated each virtual machine on the at least one host. The data store locations can be identified via configuration files for the virtual machines, wherein the configuration files can indicate a data store, a file path location, or some other location information associated with the objects. Method 300 further includes determining (302) orphan disk objects (e.g., virtual disk files) in the hyperconverged data store based on a failure to a local data store and the identified data store locations for the disk objects associated with the virtual machines. Once the orphan disk objects are identified, method 300 further provides for generating (303) a summary of the orphan objects for display to an administrator of computing environment 100. The summary may indicate names and file path locations to the orphan objects, a virtual machine name associated with the hyperconverged storage objects, or some other information associated with the orphaned hyperconverged storage objects.

In at least one example, method 300 can be performed in response to a request from an administrator, wherein the administrator may indicate the potential failed local data store. The request can be used to identify potential orphaned objects pending an update of the at least one host, pending a restart or power failure of a host, pending a change of the local data store or migration of the local data store, or pending some other event. In response to the request, operation 300 can be performed to identify the orphan disk objects associated with the local data store. As an example of an orphan disk object, a virtual machine located on host 112 may include a home disk file that is located on a local data store of local data store(s) 122, while two additional objects are mounted to the virtual machine from hyperconverged data store 140. If a failure occurs in association with the local data store, the two remaining objects from hyperconverged data store 140 can be identified and presented as part of the summary from management service 130.

In other implementations, in identifying the failure associated with a local data store, management service 130 can use the aggregated health and performance information to determine when a local data store has failed or possesses indicators that the local data store could fail. For example, host 112 may indicate in its health and performance information to host 111 that the health of a first local data store is failing. In response to the notification, method 300 can be performed that identifies the disk object locations for the virtual machines on host 112 and determines orphan disk objects from hyperconverged data store 140 because of the failure or potential failure. Once determined, a summary is generated that indicates the orphan disk objects, permitting an administrator of computing environment 100 to take actions to mitigate the effects of the failure. The mitigation techniques can be migrating the affected objects from hyperconverged data store 140 to another host (migrating an entire virtual machine or mounting the object to another virtual machine) or can perform some other operation in association with the affected disk objects.

In some examples, rather than a failure associated with a local data store, a failure can occur based on a storage controller that can control not only a local data store for a host, but one or more storage devices for hyperconverged data store 140. For example, a failure may occur with the storage controller on host 112, wherein the failure can affect one or more local data stores and a portion of hyperconverged data store 140. Here, management service 130 or one of hosts 110-112, can identify the disk objects that are affected by the failure and determine orphaned objects from the failure.

Although demonstrated as providing a summary, management service 130 can take proactive operations in association with a failure. For example, when a failure is identified or a probable failure is identified, management service 130 can initiate an operation to migrate the data from the failing data store, can attach the identified orphan objects to another virtual machine without disk objects on the failed data store, or can take some other proactive action to mitigate a failure associated with a data store. For example, if a possible failure is identified in association with a local data store of local data store(s) 122, management service 130 can identify the orphan disk objects in hyperconverged data store 140 and initiate an operation to migrate virtual machines associated with the orphan disk objects or attach the orphan disk objects to other virtual machines executing from non-failed data stores.

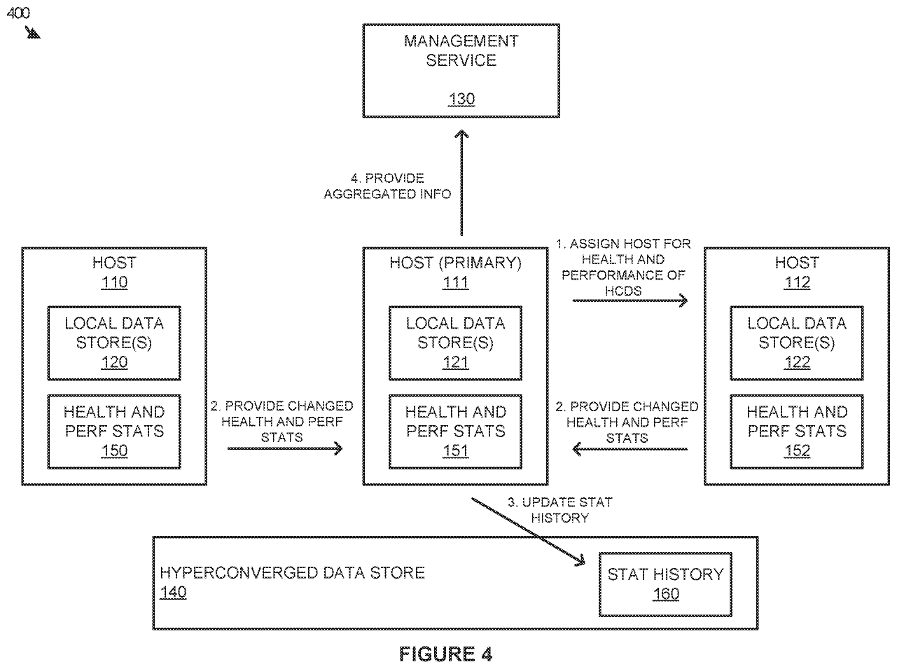

FIG. 4 illustrates an operational scenario 400 of managing health and performance information for local and hyperconverged data stores according to an implementation. Operational scenario 400 includes systems elements from computing environment 100, including hosts 110-112, hyperconverged data store 140, and management service 130.

In operational scenario 400, a host is assigned at step 1 for health and performance information in association with hyperconverged data store 140. The host that monitors health and performance information can be selected based on busyness factors associated with each of the hosts, wherein the busyness factors can include processing overhead available on the host, memory overhead available on the host, networking available on the host, or some other factor, including combinations thereof. In at least one example, each of the hosts may exchange the information to select a host that is least busy or has the most resources to allocate to identify the health and performance information associated with hyperconverged data store 140. Here, host 111 allocates the assignment to host 112. Although demonstrated as being assigned by the primary host, management service 130 can select the host to gather the health and performance information for hyperconverged data store 140, hosts 110-112 can come to a majority to select the host to gather the health and performance information for hyperconverged data store, or can select the host in some other manner.

After a host is selected, operational scenario 400 further collects health and performance information at each of the hosts in computing environment 100 (represented as health and performance statistics 150-152) and provides the collected information to host 111 at step 2. The information can be provided periodically in some examples. Here, host 110 and host 112 provide the information to host 111, wherein host 111 acts as the primary host in the cluster computing environment. Host 111 can be selected by management service 130, can be selected at random, can be selected based on the resource usage at the host, or can be selected in some other manner. From the gathered health and performance information or statistics 150-152, host 111, updates statistic history 140 that can include the progression of the health and performance for each of the hosts as a function of time at step 3. Additionally, host 111 can maintain most recent health and performance information for hosts 110-112, such that the information can be readily provided to management service 130 as required. The information can be provided periodically from host 111 to management service 130 at step 4, can be provided after a request from management service 130, or can be provided at some other interval to management service 130.

In some implementations, in providing the health and performance information to host 111, each host of host 110 and host 112 can determine whether differences exist between the health. Using host 110 as an example, host 110 can collect health and performance information at a first time and collect health and performance information at a second time. The information can then be compared to determine whether each statistic in the health and performance information differs by a threshold amount or satisfies one or more criteria. As an example, available storage in a data store can be compared from a first time to a second time to determine whether the available storage differs by a threshold value to be communicated to host 111. If the available storage does not differ by the threshold, then no update will be provided to host 111, and the available storage value from the first time can be compared again to available storage identified at a third time. The second value can be dismissed when the threshold difference is not exceeded (i.e., does not replace the first value). However, when the threshold is exceeded, an update can be provided to host 111 indicating the new available storage in association with the local data store at host 110. Hosts 111 can then use the provided value in the aggregated health and performance information for the computing environment. Additionally, host 110 can update the local health and performance stats 150 to indicate the change in value.

In some implementations, if one or more values are not changed from the first to the second time, a version number can be updated in association with the unchanged values. For example, if the available storage space in association with a data store remains unchanged from a first report time to a second report time, a notification can be communicated to host 111 indicating that no change occurred in association with the available storage, permitting host 111 to update the version (or timestamp) associated with the previously provided value.

In some implementations, management service 130 can identify data store locations for objects (i.e., disk files or other files) associated with virtual machines in the computing environment. For example, management service 130 can identify, on host 112, that a virtual machine uses a first home disk file that is located on a local data store and one or more additional objects that are located on hyperconverged data store 140. From the data store locations, a summary can be provided to an administrator that indicates potential orphan objects based on a failure to a local data store. In some examples, management service 130 provides the summary in response to a request from an administrator. In other examples, management service 130 provides the summary in response to detecting a potential failure in association with a local data store in the computing environment. The potential failure can be identified based on one or more values of the health and performance information falling below a threshold, based on a change in the health and performance information satisfying one or more criteria, or based on some other event. As an example, if a potential failure of a local data store is identified from the health and performance information from host 112, management service 130 can identify potential orphan disk objects from hyperconverged data store 140. Management service 130 can identify the virtual machines with objects on the potentially failed data store and other objects that are located on other local data stores and/or hyperconverged data store 140. Management service 130 can then identify potential orphan objects associated with objects on the failed data store. For example, a failure associated with a local data store of local data store(s) 122 can cause a home disk file to be unavailable for a virtual machine. Management service 130 can identify one or more other disk files for the virtual machine that.

In some implementations, management service 130 identifies potential failures of storage controllers that can correspond storage for local data stores and hyperconverged data store. As an example, a failure can occur in association with a storage controller at host 112. The failure can cause a failure in association with both local data stores and hyperconverged data store 140 as storage managed by the controller can be associated with both data stores. In this example, a summary of the failure can indicate the data stores that are affected by the controller failure, the disk objects that are affected by the failure, the virtual machines associated with the failure, or some other information to an administrator of the computing environment.

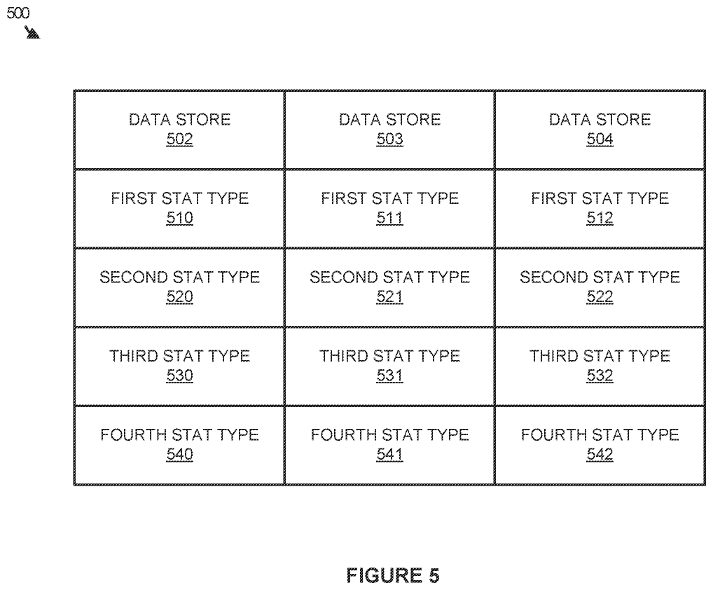

FIG. 5 illustrates a data structure 500 for providing a summary associated with health and performance information according to an implementation. Data structure 500 includes health and performance information in association with data stores 502-504, wherein the health and performance information comprise first statistic type 510-512, second statistic type 520-522, third statistic type 530-532, and fourth statistic type 540-542. The statistic types can include latency, bandwidth, IOPS, capacity usage, or some other information in association with each of the data stores in a computing environment. Data stores 502-504 can represent local data stores on hosts of the computing environment and can represent a hyperconverged data store that is distributed or available across one or more hosts.

In a computing environment, each host can monitor health and performance information for one or more data stores and provide updates to a primary host about changes to the health and performance information. Once the primary host receives the update, the host can maintain data structure 500 that aggregates the information for the various hosts. The health and performance information updates can be provided periodically, during a downtime in association with the computing environment or host, or at some other interval.

As the information is maintained, the information in data structure 500 can be communicated to a management service, wherein the management service can generate a summary that indicates health and performance information with the various data stores in the computing environment. The health and performance information can be communicated to the management service in response to a request from an administrator or can be provided when the health and performance information satisfies one or more criteria. For example, second statistic type 521 in association with data store 503 can satisfy criteria indicating a potential failure in association with data store 503 (e.g., available capacity for data store 503 falling below a threshold value). In response to identifying the potential failure a notification can be provided to the management service with information about the potentially failing data store, including health and performance information of the data store. In some examples, the management service itself can perform the identification of potentially failing data store.

In some examples, the information from data structure 500 can be communicated as a table or some other format to the administrator as part of a generated display. Additionally, the health and performance information associated with one or more of data stores 502-504 can be promoted by increasing the size, changing the color, highlighting, or otherwise promoting one or more data stores associated with potential failures. Advantageously, the display can promote data stores that require maintenance by the administrator. In some examples, in addition to or in place of providing the health and status information associated with data stores 502-504, the monitoring service can identify related disk objects for virtual machines on a potentially failed data store and determine which of the objects be orphaned after the failure of the potentially failed data store. For example, a virtual machine may have the home file object stored on data store 504, but have one or more objects stored on data store 502, wherein data store 502 represents a hyperconverged data store. When a potential failure is identified in association with data store 504, the management service can identify that the one or more objects on data store 502 will be an orphan object and can indicate information about the orphan objects in a summary to the administrator. The information can include identifiers and/or locations of the orphan objects, virtual machine identifiers associated with the orphan objects, or some other information in association with the orphan objects. In some examples, the management service can initiate a mitigation operation for the orphan objects, which can include initiating a migration of the virtual machines to alternative hosts, including the data from the potentially failed data store, mounting the orphan object to an alternative virtual machine on another host, or providing some other mitigation operation.

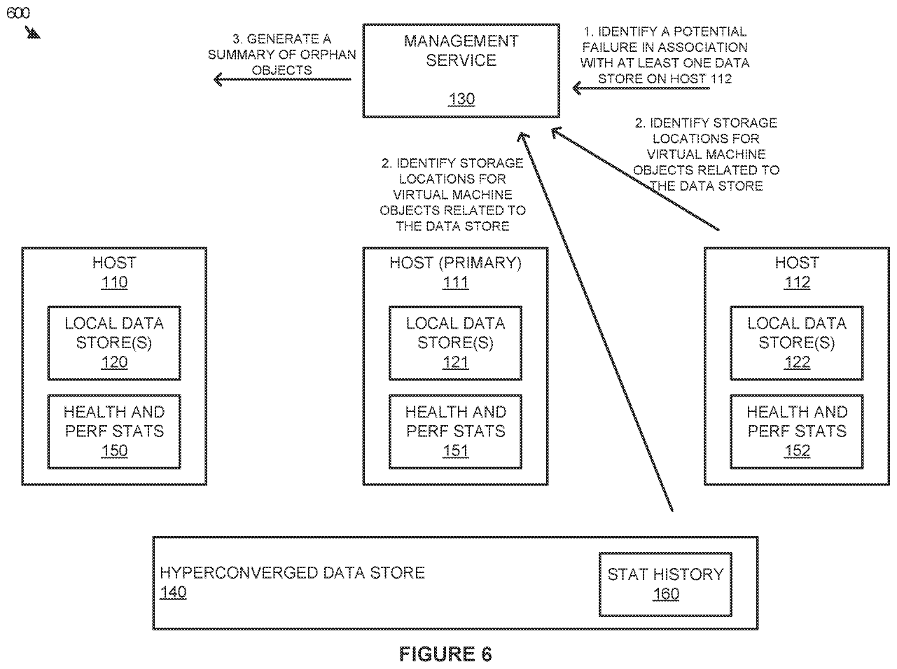

FIG. 6 illustrates an operational scenario 600 of providing an orphan disk object summary according to an implementation. Operational scenario 600 includes systems and elements from computing environment 100, including hosts 110-112, management service 130, and hyperconverged data store 140.

In operational scenario 600, management service 130 identifies, at step 1, a potential failure in association with at least one data store at host 112. In identifying the potential failure, a request may come from an administrator that indicates the potential failure for a data store. In another implementation, the failure can be identified via health and performance information obtained from the various hosts 110-112 in computing environment 100. For example, host 111 can aggregate health and performance information for hosts 110-112 and provide the aggregated information to management service 130. Monitoring service 130 then identifies a potential failure from the health and performance information. As an example, when the health and performance information indicate that a limited storage amount of storage remains available for a local data store at host 112, management service 130 can identify a potential failure in association with the data store.

After the potential failure is identified, management service 130 identifies storage locations for virtual machine objects (i.e., disk objects) associated with the data store at step 2. For example, a virtual machine may include a local home disk object that is stored on the potentially failed local data store of local data store(s) 122, while one or more additional objects can be stored as part of hyperconverged data store 140 or another local data store on host 112. In the event of a failure, the one or more additional objects can become orphans as they depend on the availability of object on the potentially failed local data store. As the orphan objects are identified for virtual machines associated with the potentially failed data store, management service 130 generates a summary of the orphan objects at step 3. The summary can include identifiers for the orphan objects (e.g., disk object names, file paths, and the like), can include virtual machine identifiers for the objects, or can include some other information in association with the orphan objects.

In some implementations, the failure for a data store can correspond to a failure of the disk controller for the data store. A failure of a disk controller can result in the failure of additional data stores or portions of data stores that share the same controller. As an example, a failure of a storage controller on host 112 can cause a failure of a local data store of local data store(s) and can cause a failure in association with one or more storage devices associated with hyperconverged data store 140 that are stored on host 112. Management service 130 can indicate the failure of the disk controller and indicate information about the disk objects that are associated with the disk controller. The summary can indicate the objects that were located on the data stores associated with the disk controller, can indicate potential orphan objects located on other data stores not affected by the failure, or can provide some other information in association with the failure of the disk controller.

Although demonstrated in the example of operational scenario 600 as generating a summary for display for an administrator of the computing environment, management service 130 can be used to implement mitigation operations in response to a potential failure. The mitigation operations can be used when an administrator indicates the potential failure of a data store (e.g., upgrade) or when management service 130 identifies a potential failure from the health and performance information for a host. In response to the failure identification, management service can identify potential orphan disk objects, and perform a mitigation action to support the orphan objects. The mitigation operation can include migrating a virtual machine from a host with the potentially failed data store to a second host, detaching the potential orphan objects from affected virtual machines and attaching the orphan objects to other virtual machines not reliant on the potentially failed data store, or some other action.

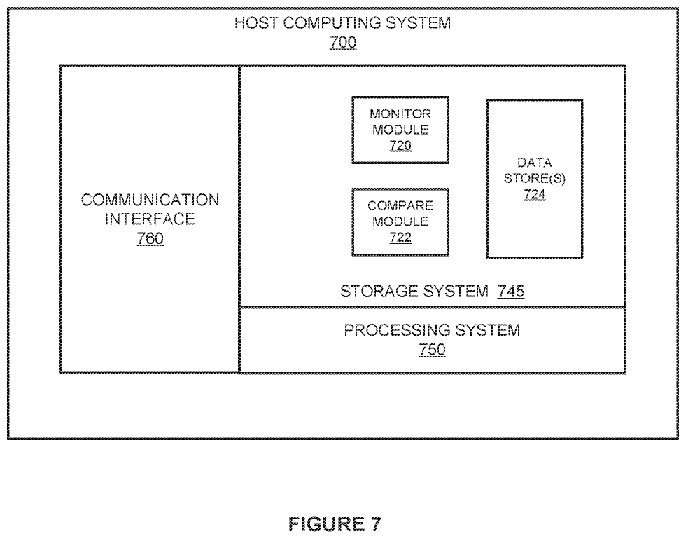

FIG. 7 illustrates a host computing system to manage health and performance information in association with local and hyperconverged data stores according to an implementation. Host computing system 700 is representative of any computing system or systems with which the various operational architectures, processes, scenarios, and sequences disclosed herein for host can be implemented. Host computing system 700 is an example of hosts 110-112 of FIG. 1, although other examples may exist. Host computing system 700 includes storage system 745, processing system 750, and communication interface 760. Processing system 750 is operatively linked to communication interface 760 and storage system 745. Communication interface 760 may be communicatively linked to storage system 745 in some implementations. Host computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 may be configured to communicate with other hosts, one or more computers providing a management service, or other computing systems.

Processing system 750 comprises microprocessor and other circuitry that retrieves and executes operating software from storage system 745. Storage system 745 may include volatile and nonvolatile, removable, and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises monitor module 720 and compare module 722. The operating software on storage system 745 may further include an operating system, utilities, drivers, network interfaces, applications, or some other type of software. When read and executed by processing system 750 the operating software on storage system 745 directs host computing system 700 to operate as a host described herein in FIG. 1-6. Storage system 745 further includes data store(s) 724 that are representative of one or more local data stores for objects associated with virtual machines. Data store(s) 724 may further include a portion of the storage used for a hyperconverged storage cluster distributed across multiple hosts.

In at least one implementation, monitor module 720 directs processing system 750 to monitor health and performance information associated with data store(s) 724. As the health and performance information is monitored, compare module 722 directs processing system 750 to determine whether the values for the health and performance information at a first time are different than the values identified at a second time. When a value has changed and satisfies criteria to indicate that the change is of significance, the health and performance information can be updated. For example, the health and performance information for a data store may include latency, bandwidth, IOPS, and available capacity that are identified at a first and second time. A value, such as latency, will be identified as updated if a change is identified from the first time that exceeds a threshold amount. If the change does not exceed the threshold amount, then no change will be identified, and the value identified at the first time will be maintained. If the change does exceed the threshold amount, then a change is identified, and the value identified at the second time will replace the value identified at the first time. Thus, values in the health and performance information will only be modified when a change is identified in a value that satisfies one or more criteria.

In some implementations, when a change is identified in at least one value for the health and performance information, an update can be communicated to a primary host, wherein the primary host can maintain health and performance information associated with multiple hosts in a computing environment. The update will indicate the change in the value, such that a current value at the primary host can be replaced with the updated value. Advantageously, rather than communicating all the health and performance information, only values that satisfy criteria will be communicated to the primary host. Accordingly, if no values changed from the first time to the second time, no update will be communicated to the primary host. The primary host can then maintain the updated heath and performance information for each of the hosts and can cache or maintain snapshots of the health and performance information as a function of time. The historical information can be stored in a hyperconverged data store that is distributed across multiple hosts in a computing environment. Although described in the previous example as providing the status updates to another host in the computing environment, computing system 700 may act as the primary host and obtain status updates from other hosts.

As the primary host, monitor module 720 can direct processing system 750 to provide health and performance information to a management service. In some examples, the management service can generate a display interface that indicates the health and performance information associated with the data stores in the computing environment. In some examples, the management service can identify potential failures or issues associated with one or more of the data stores in the computing environment. The potential failures can be identified based on one or more of the values for a data store satisfying criteria that indicate a potential failure associated with the data store. For example, the available capacity associated with a data store can fall below a threshold that indicates a failure associated with the data store is imminent. In response to identifying the potential failure a summary can be provided to an administrator of the computing environment. The summary can indicate the data store that is failing and can further indicate orphan objects that result from the failure. Orphan objects can refer to data that is mounted to the virtual machine (e.g., disk file) but would no longer be useful after the failure. For example, a home object can be stored in a failing data store of data store(s) 724. However, one or more additional objects for the virtual machine can be stored on other data stores that remain available, including local data stores or hyperconverged data stores that are distributed data stores across multiple hosts. From the summary, an administrator of the computing environment may identify potential issues with a failed data store and take remediation actions in association with the data store.

Although demonstrated as identifying the potential failure using the health and performance information gathered from the hosts in the computing environment, an administrator may provide input indicating a data store associated with a failure (e.g., a test to identify potential orphan objects if a failure were to occur). In response to the indication from the administrator, the management service can identify potential orphan objects and provide a summary to the administrator. In identifying the orphan objects, the management service can identify virtual machines with objects on the specified data store by the administrator, and identify other objects associated with the virtual machines located on other data stores. The identified other objects or orphan objects can be presented as a summary to the administrator that indicated the potentially failed data store.

While demonstrated as providing a summary to the administrator, the management service 130 may initiate one or more additional mitigation operations in association with the potentially failed data store. The mitigation operations can be used to move or attach orphan objects to virtual machines that are not reliant on the local data store, migrating the entire virtual machine, or providing some other mitigation operation.

Although demonstrated in the previous examples using a failure in association with a single volume, failures may occur that involve multiple data stores. For example, a failure can occur in association with a disk controller that controls storage in association with multiple data stores. For these failures, like the operations described above, the management service can identify orphan objects associated with virtual machines affected by the failure and present a summary of the orphan objects and/or initiate mitigation operations that can be used to mitigate the possible failures.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method comprising:
for each local data store of one or more local data stores on a first host, identifying first health and performance information at a first time;
for each local data store of the one or more local data stores on the first host, identifying second health and performance information at a second time, wherein the second time is after the first time;
in the first host, identifying one or more value differences in the second health and performance information in relation to the first health and performance information;
in the first host, selecting at least a subset of the one or more value differences that satisfy one or more criteria to be communicated to a second host; and
in the first host, communicating an update to the second host based on the identified one or more differences.

2. The method of claim 1, wherein the first health and performance information and the second health and performance information comprise latency, bandwidth, or input/output operations per second (IOPS).

3. The method of claim 1, wherein the first health and performance information and the second health and performance information comprise capacity usage associated with the one or more local data stores.

4. The method of claim 1 further comprising:
in the second host, receiving the update; and
in the second host, updating an aggregated health and performance summary based on the update.

5. The method of claim 4 further comprising:
in the second host, receiving additional health and performance updates associated with one or more additional hosts;
in the second host, updating the aggregated health and performance summary based on the additional health and performance updates.

6. The method of claim 5 further comprising:
in the second host, communicating the aggregated health and performance summary to a management service.

7. The method of claim 6 further comprising:
in the management service, identifying a potential failure of a local data store from the aggregated health and performance summary;
in the management service, identifying one or more orphan objects in one or more other data stores affected by the potential failure; and
in the management service, initiating a mitigation action for the one or more orphan objects.

8. The method of claim 1 further comprising:
in the first host, for a hyperconverged data store coupled to the first host and one or more additional hosts, identifying first health and performance information at the first time;
in the first host, for the hyperconverged data store coupled to the first host and one or more additional hosts, identifying second health and performance information at the second time;
in the first host, identifying one or more additional value differences in the second health and performance information for the hyperconverged data store in relation to the first health and performance information for the hyperconverged data store;
in the first host, selecting at least a subset of the one or more additional value differences that satisfy at least one criterion to be communicated to the second host; and
in the first host, communicating an update to the second host based on the one or more additional value differences.

9. The method of claim 1, wherein the one or more local data stores comprise a virtual machine file system (VMFS) data store or Persistent memory (PMem) data store.

10. A system comprising:
a plurality hosts;
a first host in the plurality of hosts configured to:
for each local data store of one or more local data stores on the first host, identify first health and performance information at a first time;
for each local data store of the one or more local data stores on the host, identify second health and performance information at a second time, wherein the second time is after the first time;
identify one or more value differences in the second health and performance information in relation to the first health and performance information;
select at least a subset of the one or more value differences that satisfy one or more criteria to be communicated to a second host in the plurality of hosts; and
communicate an update to the second host based on the identified one or more differences.

11. The system of claim 10, wherein the first health and performance information and the second health and performance information comprise latency, bandwidth, or input/output operations per second (IOPS).

12. The system of claim 10, wherein the first health and performance information and the second health and performance information comprise capacity usage associated with the one or more local data stores.

13. The system of claim 10, wherein the second host is further configured to:
receive the update; and
update an aggregated health and performance summary based on the update.

14. The system of claim 13, wherein the second host is further configured to:
receive additional health and performance updates associated with one or more additional hosts, wherein the additional health and performance updates correspond to one or more local data stores located on each of the one or more additional hosts; and
update the aggregated health and performance summary based on the additional health and performance updates.

15. The system of claim 14, wherein the second host is further configured to:
communicate the aggregated health and performance summary to a management service.

16. The system of claim 15 further comprising the management service executing on a computer, and wherein the management service is further configured to:
identify a potential failure of a local data store from the aggregated health and performance summary;
in the management service, identify one or more orphan objects in one or more other data stores affected by the potential failure; and
in the management service, initiate a mitigation action for the one or more orphan objects.

17. The system of claim 10, wherein the first host is further configured to:
for a hyperconverged store coupled to the first host and one or more additional hosts, identify first health and performance information at the first time;
for the hyperconverged data store coupled to the first host and one or more additional hosts, identify second health and performance information at the second time;
identify one or more value differences in the second health and performance information in relation to the first health and performance information;
select at least a subset of the one or more value differences that satisfy one or more criteria to be communicated to a second host; and
communicate an update to the second host based on the identified one or more differences.

18. The system of claim 10, wherein the one or more local data stores comprise a virtual machine file system (VMFS) data store or Persistent memory (PMem) data store.

19. A method comprising:
obtaining health and performance information associated with local data stores and a hyperconverged data store in a computing environment, wherein the computing environment comprises a plurality of hosts;
identifying a potential failure associated with a local data store of the local data stores based on the health and performance information;
identifying one or more orphan objects in one or more other data stores affected by the potential failure; and
initiating a mitigation action for the one or more orphan objects.

20. The method of claim 19, wherein initiating the mitigation action comprises migrating at least a portion of the one or more orphan objects to one or more virtual machines not reliant on the local data store.
